(19) United States
(12) Patent Application Publication
(10) Pub. No.: US 2026/0120538 A1
(43) Pub. Date: Apr. 30, 2026

(54) SYSTEM AND METHOD FOR PROVIDING A GAME

(71) Applicant: Darcy Silver, Las Vegas, NV (US)

(72) Inventor: Darcy Silver, Las Vegas, NV (US)

(21) Appl. No.: 18/926,121

(22) Filed: Oct. 24, 2024

(51) Int. Cl. G07F 17/32

(52) U.S. Cl. CPC G07F 17/3213

(57) ABSTRACT

A game with a rollable device associated with manipulating obstacles and a wheel in a game display area is provided. The game display area comprises the rollable device, a launcher, the wheel, and at least one obstacle. The wheel comprises pockets corresponding to various numbers, symbols, colors, or the like. Each pocket, individually or as a part of a group of pockets, is assigned a wager outcome. The rollable device is launched and the wheel starts to spin. The rollable device travels or moves in the game display area, and eventually lands in one of the pockets of the wheel. A predetermined payout is paid out, based on the wager outcome assigned to the pocket in which the rollable device landed.

### FIELD OF THE INVENTION

Aspects of one or more embodiments of the present disclosure relate to systems and methods for gaming, and more specifically, to a game with a rollable device associated with manipulating features and a number wheel.

### BACKGROUND

Many types of games have been developed and used for gaming, gambling, and the like. Some games comprise games of chance, or luck, often times played with money wagered by a player on the outcome. Often times, such games are implemented in commercial venues frequented by gaming customers, such as casinos, bars, and the like.

Games typically take many different forms. Some games are table games, which are played manually. These include, for example, craps, roulette, blackjack, poker, and the like. Some games include other apparatus, such as pinball, although usually not in the context of gambling. Some games utilize cards, such as blackjack, poker, and the like. Some are mechanical games, where the player manually operates a button, lever, or the like, to start and/or play the game. Some games are electronic, such as slot machines, with spinning reels that are operated electronically in response to a manual input from a user. Many mechanical games may be electronically implemented as well, such as craps, roulette, and the like. Such table games, electronic games, and the like.

An almost consistent feature in the various games associated with wagering or gambling, whether manual or electronic, is a payout based on the outcome at the end of each play. Based on some predetermined criteria, the player may receive a payout from the game, or possibly receive nothing. In the event of a payout, the amount of the payout varies, which is usually based on the actual outcome of the play.

However, such payout is usually determined differently in each game because each game is played differently, has different rules, etc. Further, each game delivers a different type of gaming experience as not all games are played in the same manner. Nor do all games feature the same procedure, method, apparatus, features, options, and the like. Some players prefer to play mechanical games, while some players prefer to play card games, usually depending on how those games are played and rewarded. What all players generally want is novelty and excitement in their gaming experience.

Accordingly, there is a need for providing a diverse gaming experience and more opportunities to play different types of games in various manners that are exciting and entertaining for players.

The Background information above is to help understand the background of the present disclosure, it may include information that does not constitute prior art.

### SUMMARY OF THE INVENTION

One or more embodiments of the present disclosure are directed to a game with a rollable device associated with manipulating features and a wheel.

According to one or more embodiments of the present disclosure, a method of

providing a game includes: providing a game display area, the game display area including: a rollable device configured to move in the game display area; a launcher configured to launch the rollable device in the game display area; a wheel having a plurality of pockets, each configured to receive the rollable device and assigned a wager outcome indicator configured to indicate a wager outcome; at least one obstacle configured (a) to impact a path or direction of a movement of the rollable device when the rollable device encounters said at least one obstacle and (b) to be activated when said rollable device encounters said at least one obstacle; providing a user interface to a user; and allowing the user to determine a wager amount by selectively operating said user interface.

In an embodiment, the wager outcome may not be displayed to the user until after the user determines the wager amount.

In an embodiment, the method may further include providing a plurality of rollable devices, wherein each of said plurality of rollable device is configured to land in one of said plurality of pockets.

In an embodiment, the method may further include determining a payout based on a wager outcome indicator assigned to one of said plurality of pockets in which the rollable device is received.

In an embodiment, the wager outcome may be one of a winning outcome or a losing outcome.

In an embodiment, if the wager outcome is the winning outcome, then the payout may be increased by an amount calculated based on the winning outcome.

In an embodiment, if the wager outcome is the losing outcome, then the payout may be decreased by an amount calculated based on the losing outcome.

In an embodiment, the method may further include displaying the game display area on an electronic device.

In an embodiment, the method may further include displaying a movement of the wheel. The movement of the wheel may include spinning of the wheel. The spinning of the wheel may be triggered by launching the rollable device.

In an embodiment, the rollable device may be a ball or a die.

In an embodiment, the method may further include allowing the user to selectively activate said at least one obstacle by selectively operating said user interface.

In an embodiment, the method may further include determining a payout when said at least one obstacle is activated. The payout may be determined based on a special value assigned to said at least one obstacle.

In an embodiment, the special value is one of a winning value or a losing value.

In an embodiment, the method may further include allowing the user to operate said at least one obstacle by selectively operating said user interface. The operation may include a movement of said at least one obstacle in different angles.

In an embodiment, said at least one obstacle may be one of a bumper, a flap, a kicker, a paddle, or a deflector.

In an embodiment, the method may further include: providing a plurality of obstacles in the game display area; and allowing the user to operate said plurality of obstacles by selectively operating said user interface. The operation may include a movement of at least one of said plurality of obstacles in different angles.

In an embodiment, two or more of said plurality of pockets are assigned to the wager outcome indicator.

According to one or more embodiments of the present disclosure, a method for playing a game is performed by a gaming system including at least one processor and at least one memory. The at least one memory includes instructions executed by the at least one processor to perform the method. The method includes: receiving a wager amount from a user, wherein the user determines the wager amount via a user interface on an electronic device; generating a first set of wager outcomes; displaying a game display area on a graphical user interface (GUI) of the electronic device, the game display area including: a rollable device configured to move in the game display area; a launcher for launching the rollable device; a wheel including a plurality of pockets, each of said plurality of pockets configured to receive the rollable device and assigned one of said first set of wager outcomes; and at least one obstacle configured to impact a path or direction of a movement of the rollable device when the rollable device encounters said at least one obstacle; and displaying at least one of said first set of wager outcomes to the user on the GUI of the electronic device; launching the rollable device; and determining a payout based on one of said first set of wager outcomes that is assigned to one of said plurality of pockets in which the rollable device is received.

In an embodiment, the one of said first set of wager outcomes may be one of a winning outcome or a losing outcome.

In an embodiment, if said one of said first set of wager outcomes is a winning outcome, then the payout may be increased by an amount calculated based on the winning outcome.

In an embodiment, if said one of said first set of wager outcomes is a losing outcome, then the payout may be decreased by an amount calculated based on the losing outcome.

In an embodiment, the game display area may further include a plurality of wager outcome indicators, each configured to display one of said first set of wager outcomes.

In an embodiment, the method may further include allowing the user to operate said launcher, said operation includes launching of said launcher.

In an embodiment, the method may further include displaying a movement of the wheel on the GUI. The movement of the wheel may include spinning of the wheel wherein said spinning is triggered by launching the rollable device.

In an embodiment, the method may further include displaying the movement of the rollable device. The movement of the rollable device may include traveling within the game display area. The movement of the rollable device may be triggered by launching the rollable device.

In an embodiment, the method may further include allowing, by said user interface, the user to operate said at least one obstacle. The operation may include moving of said at least one obstacle in various directions.

In an embodiment, the method may further include presenting the user an option on the GUI to select a design of the wheel via said user interface.

In an embodiment, said option may include presenting a plurality of designs of the wheel to the user on the GUI.

In an embodiment, said plurality of designs of the wheel may include a plurality of designs of said launcher and a plurality of designs of said at least one obstacle.

In an embodiment, the method may further include generating a second set of wager outcomes. The at least one of said second set of wager outcomes may be different from said first set of wager outcomes.

In an embodiment, the method may further include activating said at least one obstacle. The activation may be triggered when said at least one obstacle is hit by the rollable device.

In an embodiment, the method may further include: assigning a special value to said at least one obstacle; and adjusting the payout when said at least one obstacle is activated. The payout may be adjusted based on the special value.

In an embodiment, the special value may be one of a winning value or a losing value.

In an embodiment, said at least one obstacle may be one of a bumper, a flap, a kicker, a paddle, or a deflector.

### BRIEF DESCRIPTION OF THE FIGURES

FIG. 1A illustrates an example of a game according to one or more embodiments of the present disclosure.

FIG. 1B illustrates an example of a game display area of the game according to one or more embodiments of the present disclosure.

FIG. 2 illustrates an example of a wheel according to one or more embodiments of the present disclosure.

FIG. 3 is a flow diagram for a game according to one embodiment of the present disclosure.

FIG. 4A illustrates one embodiment of possible outcomes of a game that are implemented on wager outcome indicators.

FIG. 4B illustrates an alternate embodiment of possible outcomes of a game, that are implemented on wager outcome indicators.

FIG. 5A illustrates an alternate embodiment of possible outcomes of a game, that are implemented on wager outcome indicators.

FIG. 5B illustrates an alternate embodiment of possible outcomes of a game, that are implemented on wager outcome indicators.

FIG. 6A illustrates an alternate embodiment of possible outcomes of a game, that are implemented on wager outcome indicators.

FIG. 6B illustrates an alternate embodiment of possible outcomes of a game, that are implemented on wager outcome indicators.

FIG. 7A illustrates an alternate embodiment of possible outcomes of a game, that are implemented on wager outcome indicators.

FIG. 7B illustrates an alternate embodiment of possible outcomes of a game, that are implemented on wager outcome indicators.

FIG. 8 illustrates a schematic block diagram of a gaming system for playing a game according to one embodiment of the present disclosure.

### DETAILED DESCRIPTION

Embodiments are described with reference to the accompanying drawings, in which like reference numbers refer to like elements throughout. The present disclosure, however, may be embodied in various different forms, and should not be construed as being limited to only the embodiments illustrated herein. Rather, these embodiments serve as examples, and will convey the various aspects and features of the present disclosure to those skilled in the art. Accordingly, processes, elements, techniques, etc., that are not required for those having ordinary skill in the art to completely understand the aspects and features of the present disclosure may not be described. Unless otherwise noted, like reference numerals denote like elements throughout the drawings and the written description.

One or more embodiments of the present disclosure relates to a game with a rollable device associated with manipulating features and a wheel. In one embodiment, the game may be implemented in any form known in the art, or which may hereafter be invented, such as a game machine (kiosk), a table game, in an electronic application, or the like. It is anticipated that at least some embodiments will be implemented in casino establishments.

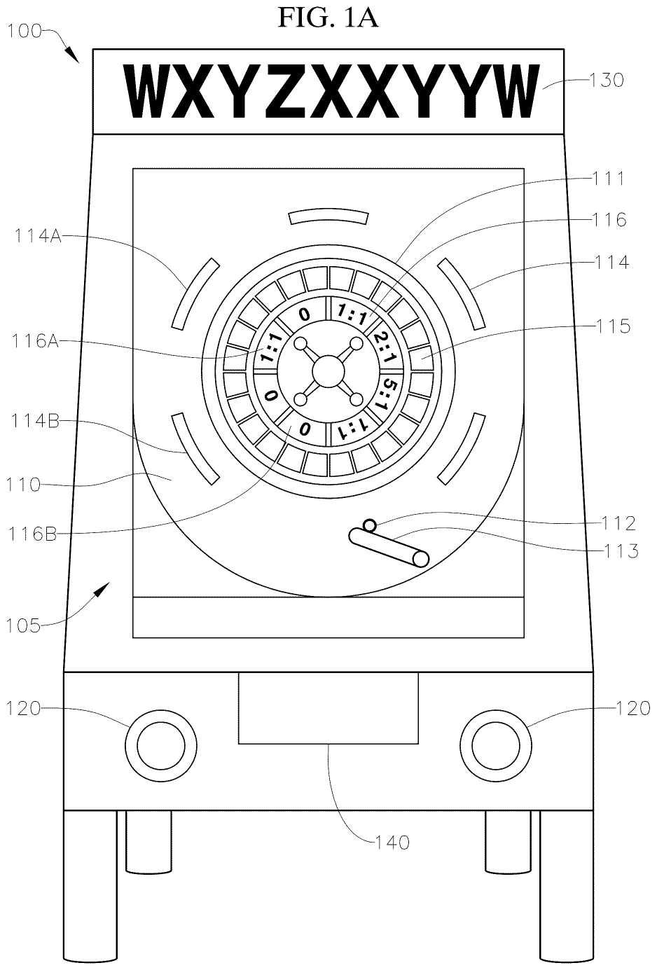

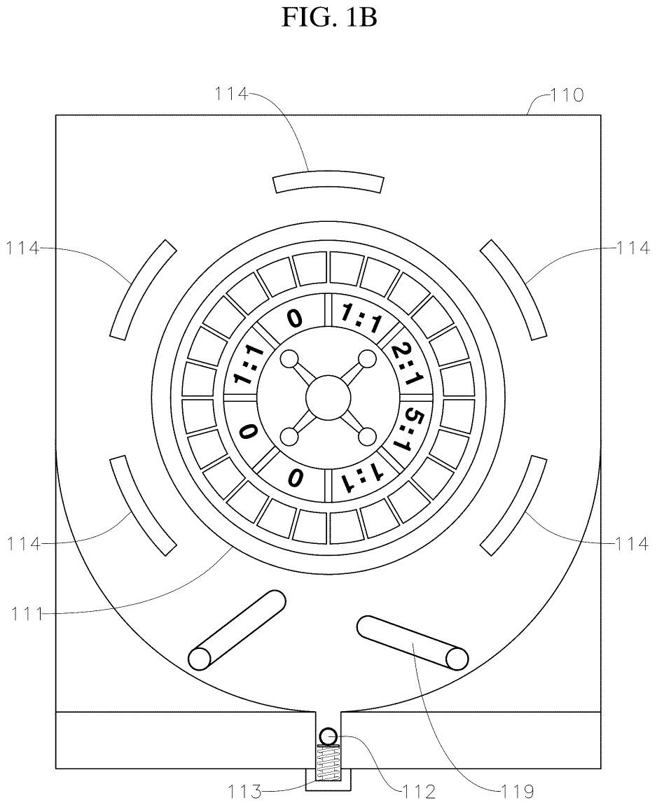

FIG. 1 shows an example of the game according to one embodiment of the present disclosure. In one embodiment, the game incorporates the concepts of multiple games such as a pinball-like game and a roulette-like game. In one embodiment, a user/player (hereinafter, the terms “player” and “user” are used interchangeably) is provided with a spinning wheel (e.g., a roulette-style wheel) implemented in a pinball-like housing unit. The spinning wheel comprises a plurality of pockets, which may be similar to pockets in a typical roulette wheel. Each pocket, or a group of pockets, is assigned with a wager outcome, which outcome may vary from game to game. A rollable device is provided in the pinball-like housing unit. In one embodiment, the rollable device is a ball, such as a small metallic ball or plastic ball, that is configured to roll. In another embodiment, the rollable device may be a dice-like device having a plurality of sides. The rollable device may be launched by a launcher (or the like) similar to how a pinball is launched in a pinball game. Also, in one embodiment, either simultaneously or shortly thereafter, the wheel starts to spin. The rollable device travels or moves within the housing unit, potentially encountering obstacles along its travel, such as bumpers, flaps, deflectors, and the like, which may operate automatically or manually controllable by the user. In one embodiment, these obstacles are akin to similar obstacle apparatuses implemented generally in pinball games and machines.

The rollable device eventually enters the area of the wheel, with perhaps circling some rotations around the wheel near the wheel's periphery. It then lands in one of the pockets of the wheel, which may or may not spin, depending on the particular embodiment. In some embodiments, the wheel itself may slow down, or even stop, to facilitate the rolling device to land in one of the pockets of the wheel. In an alternate embodiment, the rolling device slowly loses momentum, causing it to slow down progressively until it eventually slows down enough that it drops into one of the wheel's pockets. A reward/payout is then determined by the wager outcome that was assigned to the pocket in which the rollable device landed.

Referring to FIG. 1, the game includes a housing unit 105, a game display area 110, an input device 120, a display 130, and a tray 140. This embodiment may be implemented on a physical game machine 100 (e.g., kiosk) as shown in FIG. 1. In alternate embodiments, this game may also be implemented on a physical game table, in an electronic device via software, or the like. All such embodiments are anticipated.

The housing unit 105 may be a game machine, or kiosk, that is configured to host the game. The game display area 110 may be configured to display the game. In one embodiment, the game display area 110 includes a wheel 111, a rollable device 112, a launcher 113, and one or more obstacles 114. In the embodiment shown, the obstacles 114 are bumpers, although they may be flaps, deflectors, or the like, that are usually implemented in pinball machines. The wheel 111 may be a spinning wheel that is configured to spin, such as a roulette wheel. It is anticipated that in alternate embodiments, the wheel 111 may be a stationary wheel that does not spin.

The wheel 111 includes pockets 115, each corresponding to wager outcome indicators 116. Each pocket 115 is configured to be able to receive the rollable device 112. In some embodiments, one or more pockets 115 may be assigned with the same, or one, wager outcome indicator 116. For example, in the embodiment shown in FIG. 1, three pockets 115 are assigned the same wager outcome indicator 116. Each of the wager outcome indicators 116 are preferably configured to display a wager outcome. In alternate embodiments, each wager outcome indicator 116 may be configured to have, and display, a different wager outcome, which may be variable for each game, such as by being configurable by software associated therewith. In another embodiment, the wager outcome may directly correlate to the amount wagered by the player for that particular game, or even certain options that the user chooses for the particular game at the time of placing his wager. Those skilled in the art will appreciate that the software associated with the game may be configured to allow for such variations, which may be conceived in an infinite number of permutations and combinations, and which would be designed to make the game more exciting and enticing for players.

The wager outcome indicator 116 may be implemented in any manner known in the art, or which may hereafter be invented. For example, the wager outcome indicator 116 may be displayed outside the respective pocket, or inside it. The wager outcome indicator 116 may be via LEDs, or a small screen. All such variations and implementations are anticipated and are intended to be covered by the claims because they are consistent with the spirit and scope of the present invention.

As an example, one wager outcome indicator 116 may be configured to display the winning ratio of 2:1, while another wager outcome indicator 116 may be configured to display the winning ratio of 3:1. The wager outcome typically indicates the amount of the payout based on the user's wager. For example, if the user made an initial wager of $100 and the rollable device 112 landed in the pocket 115 assigned with the winning ratio of 2:1, then the initial wager ($100) is returned to the user and an additional $200 (2×$100) is paid out to the user in winnings.

In embodiments where the rollable device 112 is a dice-like device, one or more of its sides may be configured to display numbers, or symbols, or the like. In this embodiment, one of the sides of the rollable device 112 faces up when it lands in one of the pockets 115 and ceases movement. The number, or symbol, displayed on the facing-up side of the rollable device 112 may be used to determine an outcome of the game, either in combination with the payout associated with the pocket where it landed, or, such as in the case of a jackpot symbol for example, a payout based solely on the number, or symbol, that was face-up. For example, if the number displayed on the facing-up side of the rollable device 112 is “2,” then the user's wager may be doubled and paid out in winnings. Or, in an alternate embodiment, the doubled amount may be provided as a separate reward, independent of the wager outcome associated with the pocket 115 in which the rollable device 112 landed, or may be added to whatever winnings the user is entitled to receive based on the wager outcome associated with the pocket 115 in which the rollable device 112 landed.

In another embodiment, the number may be configured as a negative, such as “−1,” “−2,” or the like. In such embodiment, the user loses his or her wager, and in addition to that, the user may be charged an additional detriment out of a bag of winnings accumulated on the side, or as a penalty in a subsequent game, or the like. Which detriment would typically be a function of the number on the face-up side.

In another embodiment, one or more pockets 115 may be configured to display numbers. In this embodiment, the numbers displayed on the pockets 115 may be used to determine a winning outcome. For example, if the number displayed on the pocket 115 in which the rollable device landed is “2,” then the user's wager is doubled, and the doubled amount may be paid out as the winnings. Or, this doubled amount may be provided to the user as a separate reward independent of the wager outcome associated with the pocket 115 in which the rollable device landed, or may be added to whatever reward the user is entitled to receive based on the wager outcome associated with the pocket 115 in which the rollable device landed. In another embodiment, the number may be configured as a negative digit such as “−1,” “−2,” or the like. In this embodiment, the user loses his or her wager, and in addition to that, pay some penalty corresponding to the number “−2.”

In an alternate embodiment, one or more pockets 115 may be configured to indicate colors. In one embodiment, some pockets 115 may be configured to indicate “red” while some other pockets 115 may be configured to indicate “green,” etc. In one embodiment, each pocket 115 may be configured to indicate a different color. In another embodiment, a group of pockets 115 may be configured to indicate one common color. The colors indicated on the pockets 115 may be used to determine an outcome of the game. For example, in one embodiment, “blue” may mean a 1:1 wining ratio, “green” may mean a 2:1 winning ratio, and “red” may mean a losing outcome. In this embodiment, if the rollable device 112 lands in the blue-colored pocket 115, then the user's wager may be doubled, and the doubled amount may be paid out in winnings to the user. If the rollable device 112 lands in the green-colored pocket 115, then the user's wager may be tripled, and the tripled amount may be paid out in winnings to the user. This outcome, determined based on the color of the pocket 115 in which the rollable device 112 landed, may be provided to the user as a separate reward independent of the wager outcome associated with the pocket 115 in which the rollable device landed, or may be added to whatever payout the user is entitled to receive based on the wager outcome associated with the pocket 115 in which the rollable device landed. In another embodiment, some colors may be configured to mean a losing outcome (e.g., red). In this embodiment, the user may, for example, lose all of his wager.

It should be apparent to those skilled in the art that other variations or combinations of numbers, colors, or the like, may be implemented in association with various wager outcomes in the game. All such embodiments are anticipated as they are consistent with the spirit and scope of the present disclosure.

The launcher 113 may be operable to launch the rollable device 112, whether automatically upon the triggering of a predetermined condition or event, or manually by the user. Once launched, the rollable device 112 moves, or travels, in the display game area 110 (or the housing unit 105) until it lands on any of the pockets 115. The rollable device 112 may hit one or more obstacles 114 during such movement or travel, such as one or more bumpers in the display game area 110. Like a pinball game, when the rollable device 112 hits any of the obstacles 114, the rollable device 112 is bounced or deflected by the obstacle 114 and, depending on the direction, force, etc, of the impact caused by the obstacle 114, the resulting speed, direction, etc., of the rollable device 112 is impacted.

The game display area 110 is provided only as an example embodiment. Other designs, layouts, structures, etc., with a different number of pockets 115, obstacles 114 (e.g., bumpers), launcher 113, and/or wager outcome indicators 116 with different shapes, sizes, or designs may be implemented. In one embodiment, the game provides various designs, layouts, or structures of the game display area 110 and/or the wheel 111. In alternate embodiments, multiple designs, layouts, or structures of the game display area 110 and/or the wheel 111 may be presented to the user through the display 130 or on the game display area 110. The user may be prompted or allowed to select his or her preferred design, layout, or structure of the game display 110 (or any part thereof) and/or the wheel 111 (or any part thereof) through the input device 120, through the game display area 110, or other method or apparatus.

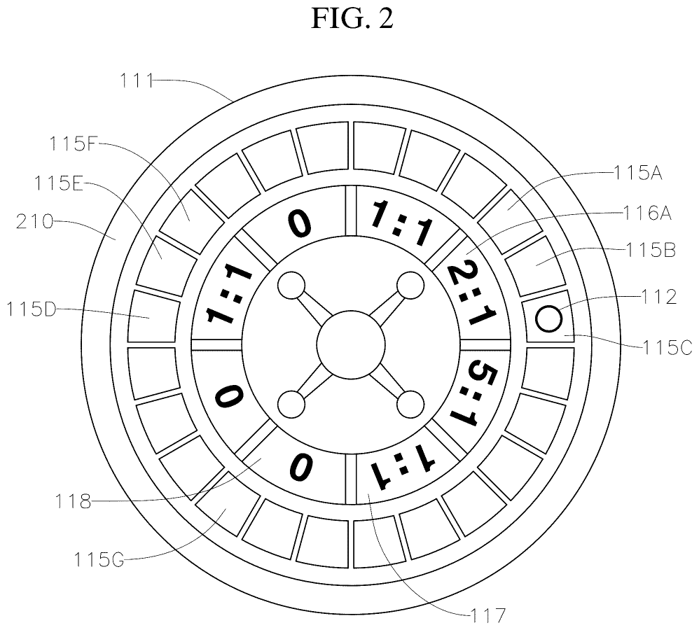

Alternatively, additional elements may be added to enhance the game experience and excitement of playing the game. For example, in addition to the obstacles 114, any suitable number or type of flippers, kickers, paddles, (e.g., 119 of FIG. 2B), or the like, may be implemented in the game, akin to such devices used in a pinball game. In such embodiments, the user may operate one or more of the flippers, kickers, etc., to cause the rollable device to eventually land in a pocket 115 in which the user prefers to place the rollable device 112. It will be apparent to those skilled in the art that other various elements that are generally known in pinball games may be utilized in the various embodiments of the present game. All such embodiments are anticipated as they do not depart from the spirit and scope of the present disclosure.

FIG. 1B shows an example of an alternative embodiment showing the game display area 100 with a different layout of the game display area 110 including the obstacles 114 (e.g., bumpers), the launcher 113, and the flippers 119. As shown in FIG. 1B, any suitable number or type of the obstacles 114, the launcher 113, the flippers 119, or the like with different shapes, designs, or sizes may be implemented on the game display area 110. All such embodiments are anticipated as they do not depart from the spirit or scope of the present disclosure.

In one embodiment, the wager outcome indicators 116 are turned off (i.e., the wager outcomes are not displayed to the user) until the user makes a wager such that the user will not know the wager outcomes before the user makes a wager. In another embodiment, some portions of the wheel 111 may be configured to not display (i.e. not shown to the user) until the user makes a wager. Those skilled in the art will recognize that this increases the excitement of the game and adds an element of surprise to the game. In this embodiment, the wager outcomes shown in the wager outcome indicators 116 and/or the wheel 111 may be partially disclosed or displayed, depending on the amount of a wager. For example, if the user makes a wager that exceeds a certain amount (e.g., $1,000), then a portion of the wager outcome indicators 116 and/or the wheel 111 may be disclosed or displayed to the user. In this example, the user may be allowed to raise his or her initial wager based on the information disclosed to the user. The user is provided with a second chance to re-consider and adjust the initial wager after seeing at least some portions of the wager outcomes and/or the wheel 111.

The input device 120 may be configured to provide a user interface for playing the game. For example, the input device 120 may comprise one or more buttons (any type of buttons including both physical buttons and electrical buttons), a touchscreen, or touchscreen buttons implemented via a graphical user interface, for receiving a user input. In one embodiment, the input device 120 may comprise a graphical user interface (GUI) on a screen that allows physical interaction with the user to operate functions associated with the game. The user may selectively use the input device 120, for example, to start, stop, or pause the game; to make, cancel, or change a wager; to operate the obstacles 114 (e.g., bumpers), the launcher 113, or the like; or to select a preferred design, shape, size, or layout of the wheel 111 or the game display area (or any part thereof).

The display 130 may be configured to display information pertaining to the game. In one embodiment, the display 130 may display the status of the game or its progression. Such information may include any winning or losing outcome of the game or the like. In another embodiment, the display 130 may be configured to display information regarding a jackpot or other games that are being played by other users in a casino. In this embodiment, the display 130 may be configured to indicate that a progressive jackpot has been triggered or the current amount of a progressive jackpot. All such embodiments are anticipated as they do not depart from the spirit or scope of the present disclosure.

The tray 140 may be a physical tray or implemented by software on an electronic device. The tray 140 may be configured to provide rewards/payouts from the game. For example, the rewards may be provided to the user in form of cash, vouchers, credits, coins, chips, or the like. In another embodiment, the rewards may be provided in the form of electronic coins, vouchers, chips, or credits. In this embodiment, the user may use his or her electronic device to receive, deposit, purchase, and store the electronic coins, vouchers, chips, or credits. For example, the user may place the electronic device (such as a smartphone or tablet) near the tray 140 such that the electronic device may communicate with the tray 140 to receive the rewards. In one embodiment, such implementation may be accomplished by signal communication between the tray 140 and the electronic device in any manner known in the art, or which may hereinafter be invented, such as by WiFi communication, Bluetooth communication, hardwired connection such as by ethernet cable, or the like. In one embodiment, a barcode or a QR code or the like may be implemented on a screen in the tray 140 that contains information about the electronic coins, vouchers, chips, or credits such as the remaining balance or the amount of a reward. By scanning or reading such a code, for example with a camera installed on an electronic device, the electronic device is able to receive information about the coins, vouchers, chips, or credits from the tray 140. In one embodiment, the user may be asked to log in or create his or her account associated with the game to play the game. In one embodiment, the tray 140 may comprise a graphical user interface (GUI) on a screen that allows physical interaction with the user to operate functions associated with the game.

In the game-machine embodiment, the game display area 110 may be configured as part of a physical game machine. For example, the game display area 110 (and/or the housing unit 105) may be configured to be displayed on a display screen installed on a game machine. In this embodiment, the display screen may be configured to electrically display one or more of the wheel 111, the rollable device 112, the launcher 113, the obstacles 114 (e.g., bumpers), the pockets 115, the wager outcome indicators 116, and/or the progression of the game.

In another embodiment, the game display area 110 may be configured as a physical game displaying area in a game machine. In this embodiment, the wheel 111, the rollable device 112, the launcher 113, the obstacles 114 (e.g., bumpers), the pockets 115, and the wager outcome indicators 116 may be physical items. In this embodiment, the user may play the game like a pinball game machine. In one embodiment, the launcher 113 may be provided as a physical launcher-type device as used in a pinball machine, included as part of the input device 120.

In another embodiment, the game display area 110 may be configured partially electronically. For example, only the wager outcome indicators 116 may be configured to be electrically displayed and other components (e.g., 111, 112, 113, 114, and 115) may be physical items. In this embodiment, the user is able to play the game like a pinball game, but the wager outcome indicators 116 may be configured to be electrically displayed on a screen in the game machine. Alternatively, the pockets 115 and/or the design of the wheel 111 may also be configured to be electrically displayed.

In the table-game embodiment, the game display area 110 may be configured as part of a physical game table. For example, the game display area 110 may be configured to be displayed on a display screen installed on a game table; configured as a physical game playing area in a game table; or configured partially electronic, in the same manner as described above for the game-machine embodiment.

In the electronic-game embodiment, the game may be implemented on an electronic device. In this embodiment, the electronic device may include a display configured to electrically display the game display area 110 and/or the other parts of the game such as 111, 112, 113, 114, 115, and/or 116. In the electronic-game embodiment, the input device 120 may be configured as electronic buttons or touch screen buttons, and the tray 140 may be configured as a virtual tray being displayed on a screen. The tray 140 may further be configured to provide rewards/payouts in the form of electronic coins, vouchers, chips, or credits to the user, and the user is allowed to receive, deposit, and store the electronic coins, vouchers, or credits in the user's account associated with the game.

The electronic device may include any suitable computer device such as a smartphone, tablet, desktop, computer, etc. In one embodiment, an application may be installed on the electronic device and the game may be configured to be played through the application running on the electronic device. In another embodiment, the game may be configured to be played on a web browser. In this embodiment, a server may be implemented to host the game. The server may be configured to be in electrical communication with the user's electronic device via a network such as the Internet.

In one embodiment, the user may create an account associated with the game by providing login credentials to a person or an entity (e.g., a casino; hereinafter “Operating Entity”) that operates the game. In one embodiment, the user may create such an account with an app downloaded onto the user's mobile device such as a smartphone or tablet. After the account is created, the user may login to his or her account to play the game, or deposit or cash out credits. The app provides all the necessary game features for the user to play the game as described herein. In another embodiment, the user may create an account with a software program downloaded onto the user's computer or the like. In this embodiment, the software program provides all the necessary game features for the user to play the game as described herein. In another embodiment, the user may create an account by visiting a website hosted by the Operating Entity. In this embodiment, the website provides all the necessary game features for the user to play the game as described herein.

In one embodiment, the game may be configured to be played by multiple players. In this embodiment, players may take turns to play the game. For example, each player may be prompted or allowed to make a wager before the game starts. In one embodiment, multiple players may be allowed to bet simultaneously. After all the players made wagers, the game starts by launching the rollable device 112. In another embodiment, a dealer may launch the rollable device 112. Depending on the placement of the rollable device (e.g., which pocket 115 the rollable device 112 lands in), each player's reward/payout is determined. In the embodiment in which flippers or kickers are implemented, one or more players may be prompted or allowed to operate flippers or kickers to cause the rollable device 112 to move into the pocket 115 which the players wish to place the rollable device 112 in.

In one embodiment, the game may be configured for playing with multiple rollable devices. In this embodiment, by playing with multiple rollable devices, the odds of winning or losing the game may increase or decrease, depending on the wager outcomes associated with the pockets 115 where the rollable devices 112 land. For example, if multiple rollable devices 112 landed only on those pockets 115 assigned with winning ratios (e.g., 2:1 or 3:1), then the user is likely to be paid out a larger amount than having a single rollable device landed on the pocket 115 assigned with a winning ratio (e.g., 2:1). In another embodiment, certain rollable device(s) may be designated as a bonus rollable device. In this embodiment, if the bonus rollable device lands in the pocket 115 with a winning outcome, then the payout may be increased by a certain amount (e.g., doubled, tripled, etc.) or an additional payout of a flat fee (e.g., $500 or $1,000) may be given to the user as a bonus reward.

In one embodiment, the game may be configured to activate one or more of the obstacles 114, for example, bumpers or the like when the rollable device 112 hits one or more obstacles 114 (e.g., bumpers). In this embodiment, one or more obstacles 114 may be assigned with a special value that indicates a loss or a win. If the rollable device 112 hits the obstacle 114 assigned with the special value that indicates a losing outcome (e.g., “Decrease Wager/Ratio”), then the wager outcome assigned with the pocket 115 where the rollable device 112 ultimately lands may be deceased by a certain amount (e.g., from 3:1 to 2:1, or 2:1 to 1:1). But if the rollable device 112 hits the obstacle 114 assigned with the special value that indicates a winning outcome (e.g., “Increase Wager/Ratio”), then the wager outcome assigned with the pocket 115 where the rollable device 112 ultimately lands may be increased by a certain amount (e.g., from 2:1 to 3:1, or 1:1 to 2:1). In one embodiment, one or more of the special values assigned to the obstacle 114 may be displayed on one side of the obstacle 114 to be seen by the user, in the display 130 of FIG. 1, or any part of the wheel 111 or the game display area 110.

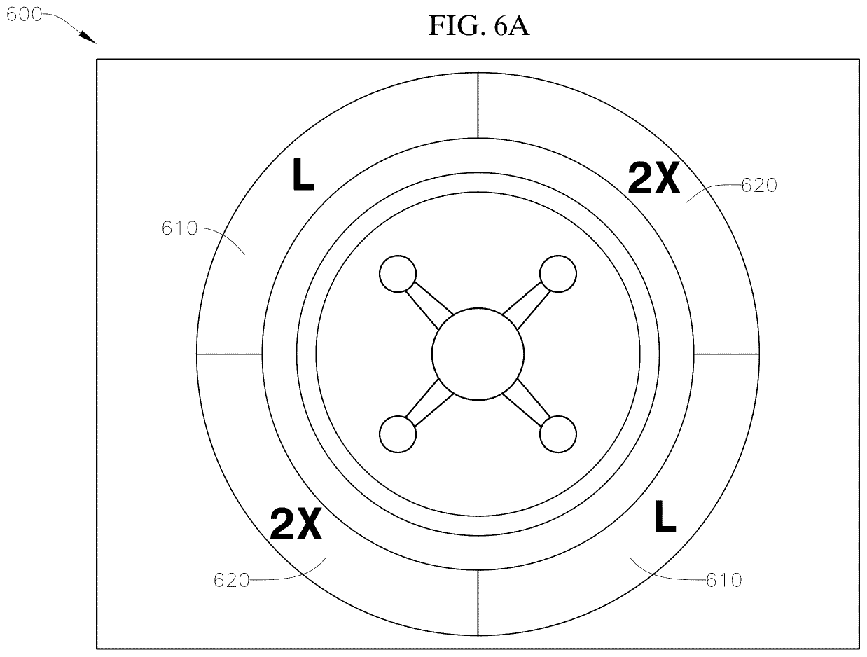

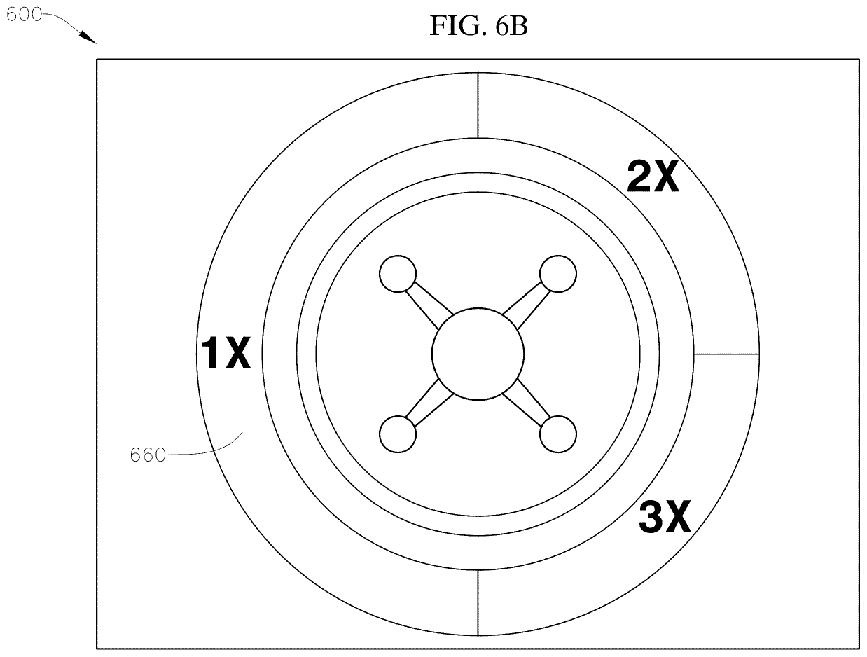

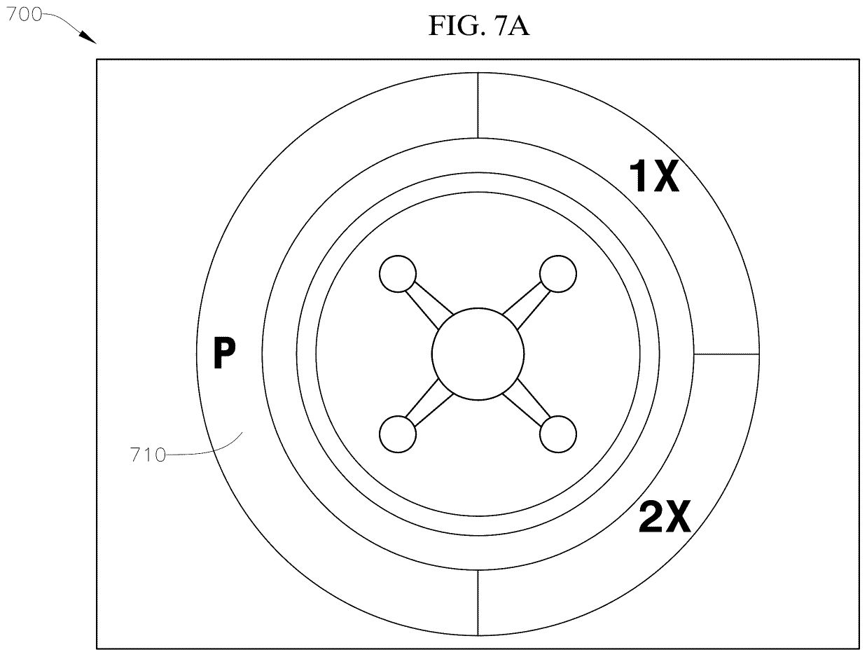

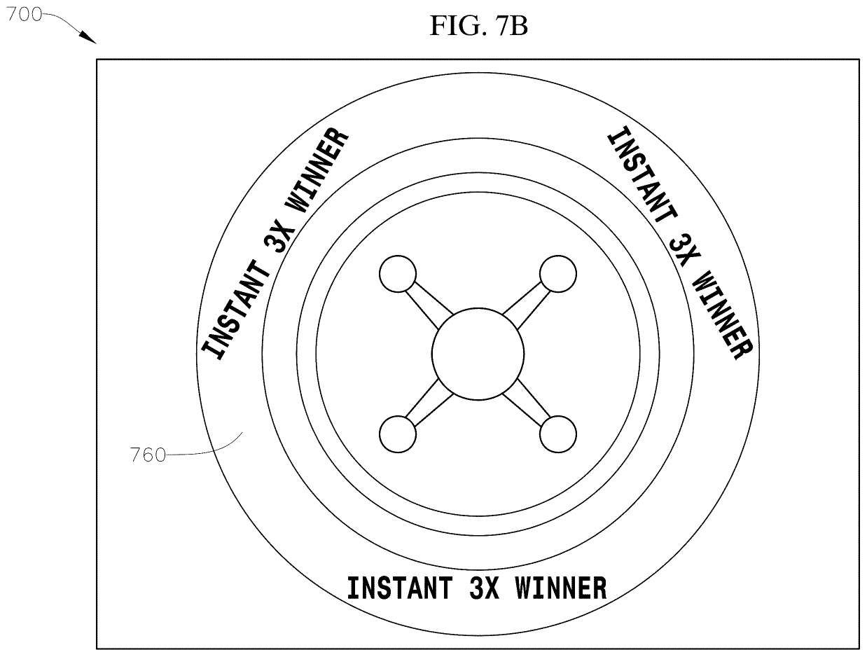

FIG. 2 illustrates an example of the wheel 111 according to one or more embodiments of the present disclosure. In this example, wheel 111 includes rollable device 112, pockets 115, wager outcome indicators 116, and an outer border 210. In one embodiment, three pockets 115 are assigned with a single wager outcome. For example, if the rollable device 112 is landed on any of the three pockets (115A, 115B, and 115C), the same wager outcome indicated by the wager outcome indicator 116A (2:1) is applied and the same winning outcome (2:1) is determined. In another embodiment, each pocket may be configured to be assigned with its own wager outcome. In this embodiment, the pocket 115A may be assigned with a 2:1 wager outcome, while the pocket 115B may be assigned with a 1:1 wager outcome and the pocket 115C may be assigned with a 5:1 wager outcome. In another embodiment, any different number of pockets may be grouped and configured to be assigned with the same wager outcome. For example, six pockets 115A to 115F may be configured to be assigned to the same wager outcome (1:1) shown in the wager outcome indicator 117. In another embodiment, six or twelve pockets may be assigned with a single wager outcome, as shown in FIG. 6A, or all of the pockets may be assigned with a single wager outcome, as shown in FIG. 7B. It should be apparent to those skilled in the art that countless different ways of assigning the pockets 115 with various wager outcomes are possible. All such ways are anticipated as they are consistent with the spirit and scope of the present disclosure.

In another embodiment, the pockets 115 may be configured to display wager outcomes. In this embodiment, one or more pockets 115 may be configured as a display unit such as an LCD screen, LED, OLED, QLED, or any other applicable display units, panels, screens, or the like.

In the game-machine embodiment or the table-game embodiment, one or more pockets 115 and/or wager outcome indicators 116 may be configured as a display unit such as an LCD screen, LED, OLED, QLED, or any other applicable display units, panels, screens, or the like. In these embodiments, the wager outcomes may be displayed on the wager outcome indicators 116. In one embodiment, the wager outcomes may be configured to change during the game play. For example, if the rollable device 112 hits one of the obstacles 114 (or the like) pre-assigned with a winning value during the game play, then the wager outcomes currently being displayed on the wager outcome indicators 116 may by increased by a certain ratio (e.g., two-fold) before the rollable device 112 lands in any of the pockets 115. However, if the rollable device 112 hits one of the obstacles 114 (or the like) pre-assigned with a losing value during the game play, then the wager outcomes currently being displayed on the wager outcome indicators 116 may by decreased by a certain ratio (e.g., two-fold) before the rollable device 112 lands in any of the pockets 115. In one embodiment, one or more of the winning or losing values assigned to the obstacles 114 may be displayed on one side of the obstacles 114 to be seen by the user, in the display 130 of FIG. 1, or any part of the wheel 111 or the game display area 110.

In one embodiment, instead of displaying the wheel 111 shown in FIG. 2, any other suitable designs, structures, or layouts for the wheel 111 may be implemented. For example, the user may be allowed to change or select the design, structure, or layout of the wheel 111. In this embodiment, the user may be provided with multiple designs, structures, or layouts of the wheel 111 displayed on the display unit of the electronic device or the input device 120 such that the user may select a design, structure, or layout of the wheel 111 the user wishes to apply to the game.

In FIG. 2, the wager outcome indicator 118 is configured to display a losing outcome (e.g., “0”). For example, if the rollable device 112 is landed on the pocket 115G, then the wager outcome displayed on the wager outcome indicator 118 is applied to calculate a reward/payout. In this example, since the wager outcome indicator 118 is “0,” the user is not rewarded, and the user's wager is not returned to the user. A varying range of combinations of winning or losing outcomes may be displayed on the wager outcome indicators 116 with each wager (e.g., each round of the game). In one embodiment, the number of losing and/or winning outcomes change each round. For example, if there are more losing outcomes arranged in any round of the game, the greater the multiplier on the winning outcomes may be generated and displayed on the wager outcome indicators 116 to make the game more fair while still maintaining entertaining value of the game.

In one embodiment, the wager outcomes may be configured to be displayed on different parts of the wheel 111. For example, one or more of the wager outcomes may be configured to be displayed on the outer boundary 210 of the wheel 111 or in some other parts of the wheel 111, e.g., displayed on the center part of the wheel 111.

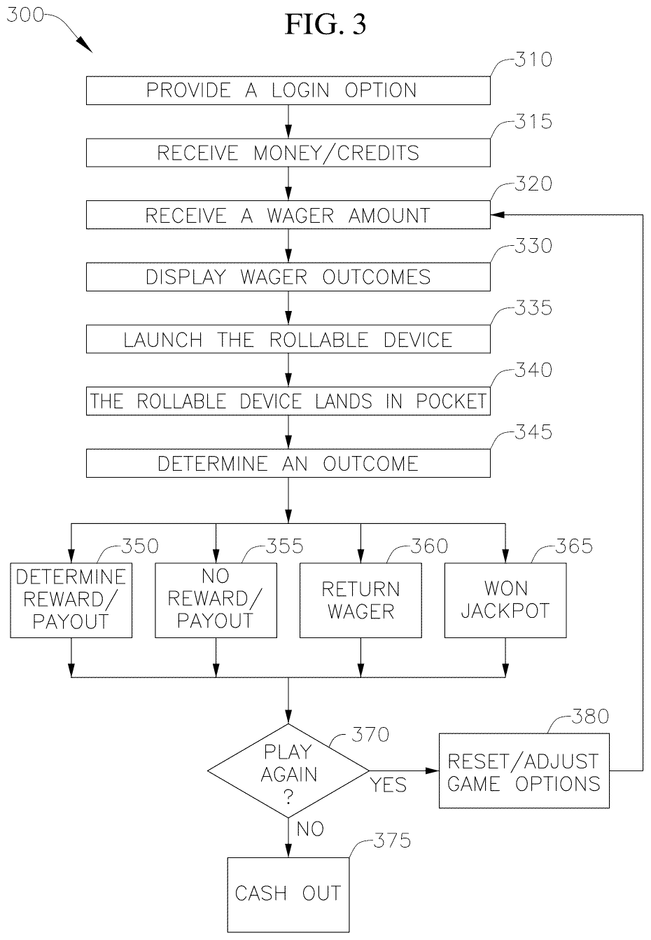

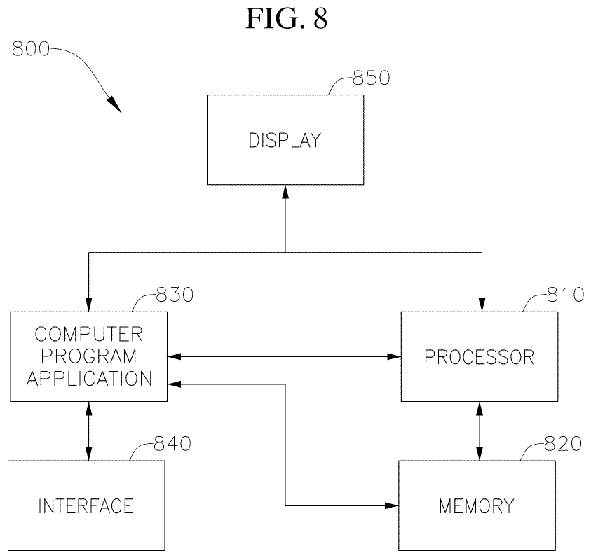

FIG. 3 shows a flow diagram for providing a game according to one embodiment of the present disclosure. FIG. 8 shows a schematic block diagram of a gaming system for playing the game according to one embodiment of the present disclosure. For example, the system 800 of FIG. 8 may be configured to perform the method illustrated by flowchart 300 in FIG. 3. However, the present disclosure is not limited to the sequence or number of the operations of the method illustrated by flowchart 300, and can be altered to any desired sequence or number of operations as would be evident to one skilled in the art. For example, in some embodiments, the order may vary, some of the processes may be performed concurrently or sequentially, the method may include fewer or additional operations, or the like.

Referring to FIG. 3, the method starts with providing a log-in option to a user at block 310. The user may play the game with or without the log-in. In one embodiment, the user may opt in to log in to his or her account associated with the game. In one embodiment, the game may be configured to allow the user to log-in through the display 130 and/or the input device 120 in the game-machine embodiment or the table-game embodiment. For example, the user is allowed to enter in his or her credentials through the interface of the input device 120 (e.g., buttons or a touchscreen). In the electronic-game embodiment, the log-in procedure is provided through an electronic device. For example, the display unit of an electronic device such as a touchscreen may be configured to provide the user interface for the user to enter in his or her credentials, or hard buttons such as a keyboard may be configured to provide the user interface for the user to enter in his or her credentials.

Next, at block 315, money or credits are received from the user to play the game. In one embodiment, credits may be in form of vouchers, coins, chips, or cards (e.g., casino membership cards or the like). In the game-machine embodiment or the table-game embodiment, the user may be prompted or allowed to insert in cash or credits directly into one or more slots (e.g., the tray 140) of the game machine or the game table. In this embodiment, the user may be allowed to make a payment with a credit card or cash to purchase credits for playing the game. In another embodiment, credits may be in form of electronic credits such as e-vouchers, e-coins, e-chips, or e-cards (e.g., casino membership cards or the like). In this embodiment, the user may be prompted or allowed to use one of these electronic credits to play the game, or purchase the electronic credits with cash, credit cards, or other applicable payment methods. Such electronic credits may be used by the user to play the game in all types of embodiments. Regardless of payment methods or the form of credits, the user is prompted or allowed to purchase “credits” for playing the game.

At block 320, a wager amount is received from the user. In one embodiment, the user is promoted or allowed to determine/select a wager amount. The amount may be freely determined by the user without any limit, or a minimum-maximum range may be provided to the user. Once the wager amount is determined, the wager amount is deducted from the user's credits. In the game-machine embodiment or the table-game embodiment, the user is prompted or allowed to determine/select a wager amount through use of the input device 120. In the table-game embodiment, the user may be prompted or allowed to determine/select a wager amount by manually selecting that amount and placing coins, chips, or the like in that amount on a designated spot in a game table. In the electronic-game embodiment, the user is prompted or allowed to determine/select a wager amount through the electronic device. In one embodiment, the user may play the game by making a wager with cash.

At block 330, wager outcomes are displayed to the user. The wager outcome indicators 116 may be configured to display the wager outcomes to the user. In one embodiment, this step is not performed until the block 320 is performed. In other words, wager outcomes are not shown to the user until the user makes a wager.

In the game-machine embodiment or the table-game embodiment, wager outcomes may be configured to be displayed on a display unit such as an LCD screen, LED, OLED, QLED, or any other applicable display units, panels, screens, or the like. In these embodiments, the wager outcome indicators 116 may be configured to be implemented on such a display unit or device. In the table-game embodiment, in which, the game is played on a traditional casino style, the wager outcomes may be manually displayed on the wheel 111 or the wager outcome indicators 116 by a dealer. In this embodiment, the wager outcome indicators 116 may be configured as a card indicating a wager outcome.

In the electronic-game embodiment, wager outcomes may be configured to be displayed on the display screen of an electronic device such as a smartphone, tablet, or computer. In this embodiment, the wager outcome indicators 116 are configured to be implemented on such a screen of an electronic device.

In another embodiment, at block 330, other elements of the game may also be displayed to the user, for example, the rollable device 112, the launcher 113, and/or the obstacles 114 (e.g., bumpers) such that the user may see these elements before or about at the same time as the wager outcomes are presented to the user. Alternatively, these other elements may also be configured to be displayed to the user at a different time or stage of the game.

At block 335, the rollable device 112 is launched. In one embodiment, the rollable device 112 may be launched by the launcher 113. In one embodiment, the launching of the rollable device 112 may be automatically triggered in response to displaying of the wager outcomes or when other condition(s) is met. For example, the rollable device 112 may be automatically launched by the launcher 113 when the user's wager is received at block 320 or when the user activates the game by pressing a button or the like (e.g., “Start” or “Launch” button). In one embodiment, the input device 120 (or an electronic device) may be provided with a user interface for the user to launch the game.

In another embodiment, the rollable device 112 may be launched manually by the user. In this embodiment, the user is allowed to use the launcher 113 to launch the rollable device 112 like pinball. Once the rollable device 122 is launched, the rollable device 122 moves or travels around in the wheel 111 (or the housing unit 105).

In the table-game embodiment where the rollable device 112 (and the wheel) is provided as a physical item, the rollable device 112 may be manually launched by the dealer or the user like roulette (e.g., tossing the rollable device into the wheel 111). In another embodiment, the rollable device 122 may be launched by a physical device or machine that is specifically designed to launch the rollable device 112. Any suitable method or system known by a person of ordinary skill may be utilized to be used as the physical device or machine to launch the rollable device 122. In the game-machine embodiment where the rollable device 112 is provided as a physical item, the rollable device 112 may be manually launched by a user like pinball (e.g., pushing/pulling a button or lever to operate the launcher 113). In this embodiment, the input device 112 may be configured to provide that type of user interface for launching the rollable device 112.

In the table-game embodiment or the game-machine embodiment where the rollable device 112 (and the wheel 111) is implemented on an electronic display, the rollable device 112 and its movement may be electrically displayed on a display unit, such as an LCD screen, LED, OLED, QLED, or any other applicable display units, panels, screens, or the like, which is implemented on the game table or the game machine. In this embodiment, the launcher 113 may also be electrically displayed on the display unit or device, and the rollable device 112 may be launched by the launcher 113 either automatically in response to an activation of certain conditions, or manually by the user.

In the electronic-game embodiment, the rollable device 112 (and the wheel 111) may be electrically displayed on a display unit. In this embodiment, the launching of the rollable device 112 and its movement are electrically displayed on the display unit of an electronic device. Like the other embodiments, the user may manually launch the rollable device 112 by operating the launcher 113. In this embodiment, the launcher 113 may be activated or controlled through the user interface of the electronic device such as physical buttons, soft buttons, a keyboard, a touchscreen, etc.

At block 340, the rollable device 112 lands in at least one pocket 115 when the wheel 111 stops spinning and/or the rollable device 112 ceases its movement. In those embodiments where the rollable device 112 (and the wheel 111) is provided as a physical item, the rollable device 112 lands in a physical pocket 115. In those embodiments where the rollable device 112 (and the wheel 111) is implemented on an electronic device, the rollable device 112's landing in one of the pockets 115 is electrically displayed through the screen of the electronic device.

In one embodiment, one or more obstacles 114 (e.g., bumpers) may be configured to be operated by the user (or the dealer) to add more excitement to the game. For example, one or more obstacles 114 may be configured to rotate in various angles or move in any direction in a certain distance depending on how the user or dealer controls. The user may be prompted or allowed to control, through the input device 120 or any suitable user interface provided in an electronic device, the movement of the obstacles 114 in order to direct the rollable device 112 toward the pocket 115, which the user wishes to place the rollable device 112 in.

In one embodiment, one or more obstacles 114 may be configured to increase or decrease one or more of the wager outcomes shown in the wager outcome indicators 116. For example, if the rollable device 112 hits the obstacle 114A (FIG. 1), then the wager outcome shown in the wager outcome indicator 116A (FIG. 1) (and one or more of the other wager outcome indicators 116) may be increased by a certain ratio (e.g., from 1:1 to 2:1). If the rollable device 112 hits an obstacle 114B, then the water ratio shown in the wager outcome indicator 116B (and one or more of the other wager outcome indicators 116) may be decreased by a certain ratio (e.g., from 2:1 to 1:1). These ratio changes are provided only as examples, and any other suitable changes in the wager outcomes may be applied, and implementation of such various changes in the game will vary by embodiment.

In another embodiment, in addition to the obstacles 114, other elements such as flappers or kickers may also be added to the wheel 111 to enhance playability of the game and to make the game more diverse and complicated, as described above with respect to FIG. 1.

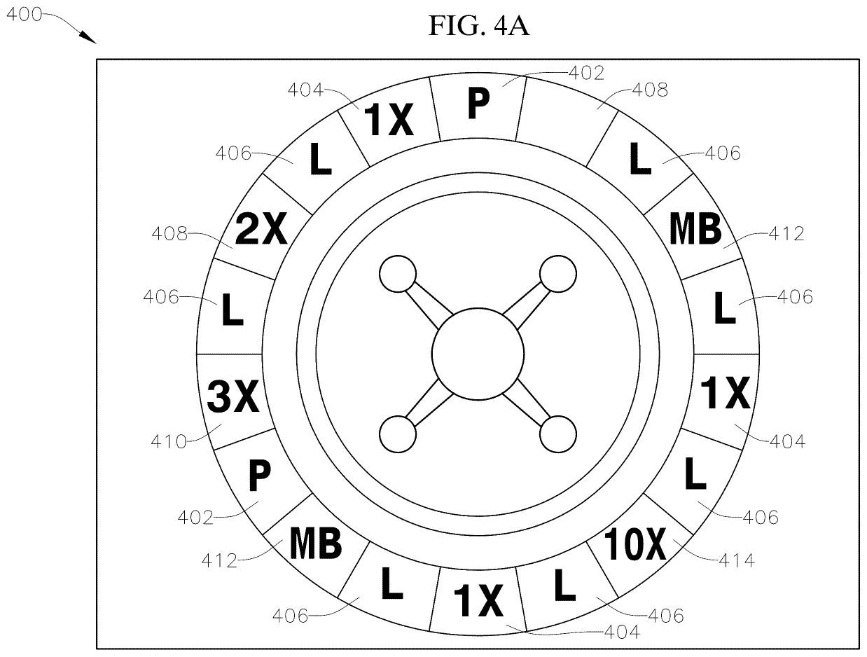

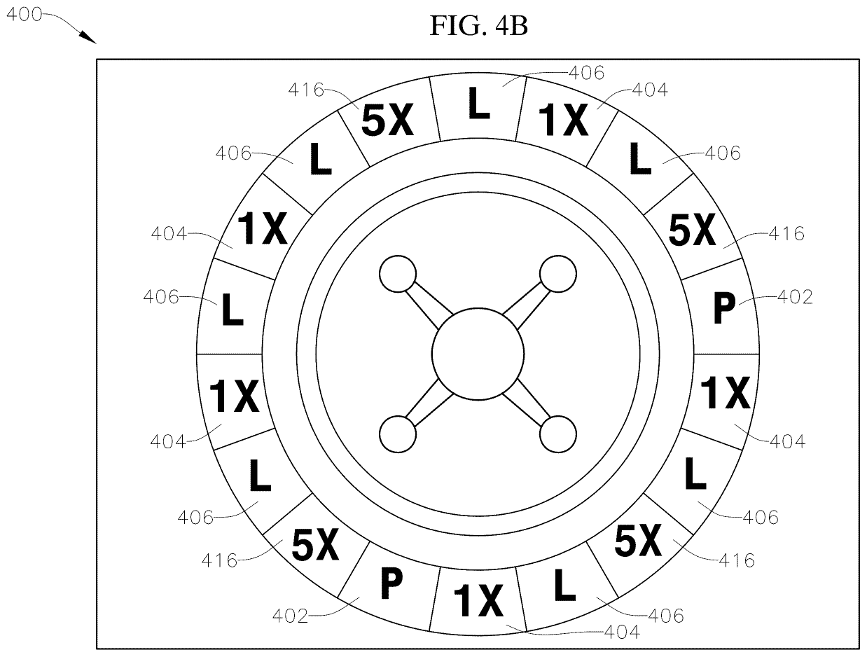

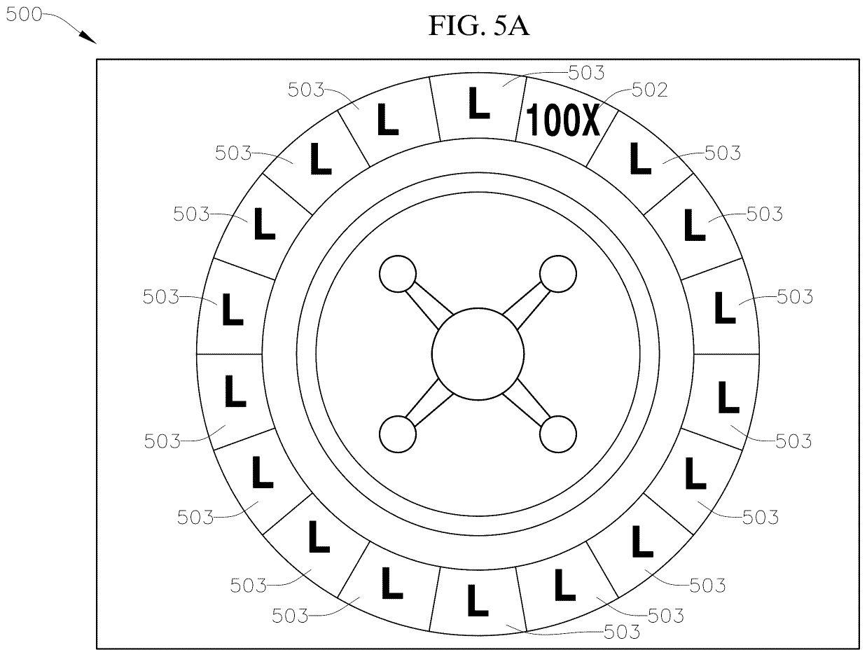

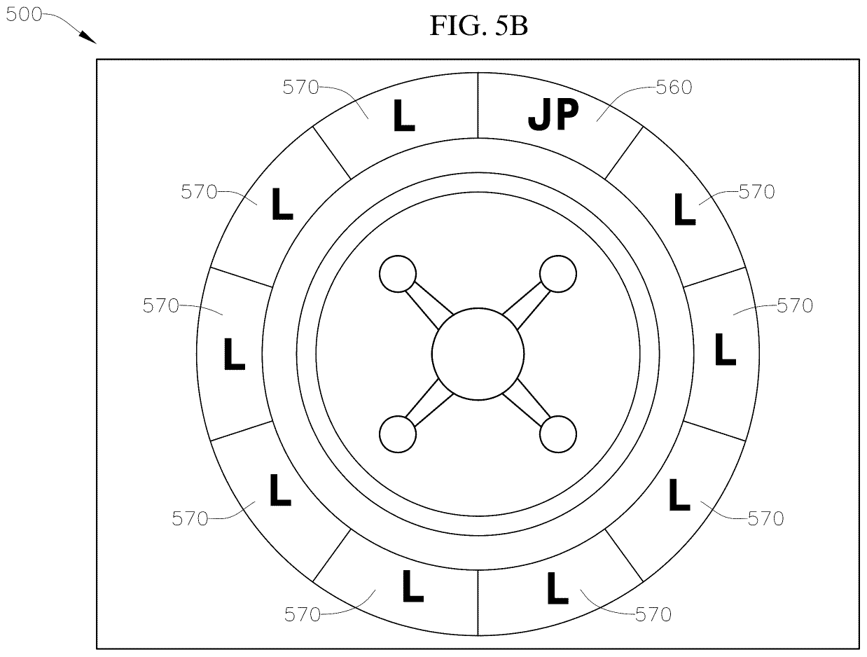

At block 345, an outcome of the present round of the game is determined. First, the pocket 115 in which the rollable device 112 landed is determined. Next, the wager outcome indicator 116 to which the pocket 115 (in which the rollable device 112 landed) is assigned to is determined. Depending on the wager outcome indicated in that wager outcome indicator 116, an outcome is determined. If the wager outcome indicated a winning ratio (e.g., 1:1 or 2:1), then it is determined that the user won this round of the game. If the wager outcome indicated a losing outcome (e.g., “L”) (406 of FIG. 4A), then it is determined that the user lost the present round of the game. If the wager outcome indicated a push (e.g., “P”) (402 of FIG. 4A), then it is determined that there is a tie. If the wager outcome indicated a jackpot (e.g., “JP”) (560 of FIG. 5B), then it is determined that the user has won a jackpot.

If it was determined that the user won the game at block 345, then a reward is determined at block 350, in the same manner as described below with respect to FIG. 4A.

If it was determined that the user lost the game at block 345, then it is further determined that there is no reward at block 355. In one embodiment, the user is not returned with his or her wager.

If it was determined that the game was tied at block 345, then it is further determined to return the user's wager at block 360. The user's wager is returned to the user but no reward is given.

If it was determined that the user won a jackpot at block 345, then a jackpot is determined at block 365, in the same manner as described below with respect to FIG. 5B.

In one embodiment, the game may be configured to determine other types of outcomes. For example, a wager outcome may indicate a multiball (e.g., “MP”) (412 of FIG. 4A). If it was determined that the wager outcome indicated the “MP,” then one or more rollable devices 112 may be added to the game, in the same manner as described below with respect to FIG. 4A.

Next, at block 370, whether or not the game will be played again for another round is determined. For example, the user may be prompted or allowed to determine whether or not to play the game again for another round.

If the user decided not to play the game again, then the user is prompted or allowed to cashout at block 375. In one embodiment, the user may cashout the remaining balance of his or her credits in the account. In the embodiment where physical type credits are utilized such as coins, chips, and casino cards, the user may cashout those physical coins, chips, or the remaining balance in the casino cards. In another embodiment, the user may cashout his or her remaining credits by exchanging those credits with cash.

If the user decided to play the game again for another round, then various game options may be reset or adjusted at block 380. In one embodiment, the user may be prompted or allowed to select a new design, structure, or layout of the wheel 111. For example, the user may select a new wheel 111 with different types or numbers of the obstacles 114, the pockets 115, and/or the rollable devices 112. The user may also change the locations or designs of the obstacles 114, the pockets 115, and/or the rollable devices 112. In the table-game embodiment, a dealer may be allowed to select a new design, structure, or layout of the wheel 111.

In one embodiment, the wager outcomes shown in the wager outcome indicators 116 may be updated or changed. For example, after playing one round of the game, the wager outcomes may be randomly re-generated on the wager outcome indicators 116 displayed on the display unit of an electronic device. In the table-game embodiment, the wager outcome indicators 116 may be manually replaced with new wager outcome indicators 116 with different wager outcomes by a dealer.

The above steps may repeat until the user decides to stop playing the game, for example, at block 370, or at any stage of the game. In one embodiment, the game may be configured to be paused for a short break after played for a certain number of rounds, e.g., five rounds.

Although the methods and apparatus described above, including those corresponding to the flow charts and figures in this application, have been described separately, it is anticipated that any of the methods disclosed can be implemented individually or combined in any combination. Any of the methods, apparatus, implementations, or procedures described herein can include machine-readable instructions for execution by: (A) one or more processors, (B) one or more controllers, and/or (C) any other suitable processing hardware. Any apparatus, software, or method disclosed herein can be embodied in software stored on a non-transitory tangible medium such as, for example, a flash memory, a CD-ROM, a floppy disk, a hard drive, a digital versatile disk DVD, a USB stick, or other memory devices. Those skilled in the art will recognize that the entire method and/or parts thereof could alternatively be executed by a device other than a controller and/or embodied in firmware or dedicated hardware in a known manner. For example, it may be implemented by an application specific integrated circuit (ASIC), a programmable logic device (PLD), a field programmable logic device (FPLD), discrete logic, or the like.

Although specific methods and apparatus are described with reference to flowcharts depicted herein, persons of ordinary skill in the art will appreciate that many other methods of implementing machine readable instructions may alternatively be used. For example, the order of execution of the steps may be changed, and/or some of the steps described may be changed, eliminated, or combined.

FIG. 4A illustrates one embodiment of possible outcomes of the game that are implemented on the wager outcome indicators 116. This embodiment includes a total of eighteen (18) wager outcome indicators 116.

In FIG. 4A, there are two wager outcomes shown as “P” (“Push”) in the wager outcome indicators 402. “P” means a tie. For example, if the rollable device 112 lands in the pocket 115 assigned with one of the “P” wager outcomes, then the user is given back his or her wager. There is no winning or losing outcome in this example. The user may play the game again.

In FIG. 4A, there are three wager outcomes shown as “1×” (“1 Time Bet Payout) in the wager outcome indicators 404.” “1×” means a winning outcome by a 1:1 winning ratio. For example, if the rollable device 112 lands in the pocket 115 assigned with one of the “1×” wager outcomes, then the user is given back his or her wager, and additional credits or the like in the amount equal to the user's wager is given to the user in winnings. There are three wager outcomes shown as “L” (“Lost Bet”) in the wager outcome indicators 406. “L” means a losing outcome. For example, if the rollable device 112 lands in the pocket 115 assigned with one of the “L” wager outcomes, then the user is not given back his or her wager, and the user has no reward. There are two wager outcomes shown as “2×” (2 Times Bet Payout) in the wager outcome indicators 408. “2×” means a winning outcome by the winning ratio of 2:1. For example, if the rollable device 112 lands in the pocket 115 assigned with one of the “2×” wager outcomes, then the user is given back his or her wager, and additional credits or the like in the amount of two times the user's wager is given to the user in winnings.

Still referring to FIG. 4A, there is only one wager outcome shown as “3×” (“3 Times Bet Payout”) in the wager outcome indicators 410. “3×” means a winning outcome by the winning ratio of 3:1. For example, if the rollable device 112 lands in the pocket 115 assigned with the “3×” wager outcome, then the user is given back his or her wager, and additional credits or the like of three times the user's wager is given to the user in winnings.

There are two wager outcomes shown as “MB” (“Multi rollable device Launch”) in the wager outcome indicators 412. “MB” means that one or more additional rollable devices may be launched. For example, one or more additional rollable devices may be played in the game, and thus, players are given more opportunities of winning or losing the game by playing it with multiple rollable devices. In this embodiment, the user is rewarded based on the wager outcomes shown in the two wager outcome indicators (if two rollable devices are used) 116 assigned with the pockets 115 in which the two rollable devices 112 land. For example, if one of the rollable devices 112 lands in the pocket 115 assigned with the “1×” wager outcome in 404 and the other rollable device 112 lands in the pocket 115 assigned with the “2×” wager outcome in 408, then the user is given back his or her wager, and additional credits or the like in the amount of three times (1×+2×) the user's wager is given to the user in winnings. In this embodiment, if one of the rollable devices 112 lands in the pocket 115 assigned with the “MB” wager outcome in 412 again, then one additional rollable device 112 may be added to the game, allowing players to play the game with one additional rollable device and rewarding players based on the wager outcomes shown in all of the wager outcome indicators 116 assigned to the pockets in which the rollable devices 112 land. In another embodiment, the “MP” means just providing a bonus round to the user. For example, the user is given an opportunity to play the game one more time without making a wager again.

Still referring to FIG. 4A, there is only one wager outcome in shown as “10×” (“10 Times Bet Payout”) in the wager outcome indicator 414. “10 Times” means a winning outcome by the winning ratio of 10:1. For example, if the rollable device 112 lands in the pocket 115 assigned with the “10×” wager outcome in 414, then the user is given back his or her wager, and additional credits or the like in the amount of ten times the user's wager is given to the user in winnings.

The wager outcomes and the associated wager outcome indicators 116 in FIG. 4A are provided only as examples and any other suitable designs, shapes, structures, or layouts of the wager outcome indicators 116 with different numbers or sizes may be utilized according to one or more embodiments of the present disclosure. Any other variations or combinations of wager outcomes may also be implemented on the wager outcome indicators 116. For example, FIG. 4B shows other examples of wager outcomes, such as a “5×” wager outcome shown in the wager outcome indicator 416. “5×” means a winning outcome by the winning ratio of 5:1. It should be noted that all such embodiments, or any variation thereof, are anticipated and are consistent with the spirit and scope of the present disclosure.

FIG. 5A illustrates an alternate embodiment of possible outcomes of the game that are implemented on the wager outcome indicators 116. In FIG. 5A, except one wager outcome shown as “100×” in the wager outcome indicator 502, all of the other wager outcomes in the wager outcome indicators 503 are shown as “L,” which means a losing outcome. “100×” (“100 Times Bet Payout”) means a winning outcome by the winning ratio of 100:1. If the rollable device 112 lands in the pocket 115 assigned with the “100×” wager outcome in 502, the user is given back his or her wager, and additional credits or the like in the amount of a hundred times the user's wager is given to the user in winnings. In this embodiment, only one wager outcome is provided as “100×” and no others are provided as indicating a winning outcome. This is because since there are more losing outcomes in the wheel 111, the greater multiplier (e.g., “100×”) is applied to the winning outcome to balance the odds of losing or winning the game.

FIG. 5B illustrates an alternate embodiment of possible outcomes of the game that are implemented on the wager outcome indicators 116 according to one or more embodiments of the present disclosure. In FIG. 5B, there are ten wager outcomes shown in the wager outcome indicators 116. In this embodiment, multiple pockets may be assigned to a single wager outcome indicator. For example, in this embodiment, two or more pockets may be assigned to each wager outcome indicator. However, any other suitable number of the pockets 115 may be assigned to a single wager outcome indicator, such as those ones depicted in FIGS. 6A and 6B.

In FIG. 5B, except the wager outcome shown as “JP” in the wager outcome indicator 560, all of the other wager outcomes are shown as “L” in the wager outcome indicators 570, a losing outcome. The “JP” (“Jackpot”) means a jackpot. In one embodiment, if the rollable device 112 lands in the pocket 115 assigned with the “JP” wager outcome 560, then the user wins a jackpot. The jackpot may be configured as an accumulated amount of betting money in any single round of the game where no user has won the game. The jackpot may be determined to be such an accumulated amount of betting money until any user wins the game or until any suitable number of rounds are played in the game without any winner. In another embodiment, the jackpot may simply be a certain amount of money, or any specific amount of money calculated based on the user's wager. For example, the jackpot may be determined as a fixed amount such as $10,000 (or any other suitable amounts), or 5× or 10× of the user's wager. In the embodiment in which the rollable device is a dice-like device, the user wins a jackpot if the facing-up side of the rollable device shows a jackpot symbol when the rollable device is landed in one of the pockets 115.

In another embodiment, if the user wins the game for a certain number of rounds or meets a certain criterion, the user wins a jackpot. For example, the user wins the jackpot after winning five straight rounds of the game. In another embodiment, the user wins the jackpot if one of the obstacles 114 (or the like) is hit by the rollable device 112 more than a certain number of times during the game. Any information about the jackpot, the progress of achieving the jackpot, requirements or conditions for achieving the jackpot, and/or how close a user is to win the jackpot may be displayed on the display 113 of FIG. 1, or displayed on a display unit of an electronic device.

In another embodiment, the jackpot is an accumulated value progressively over time as users play the game along with other games in a casino. For example, the game may be configured to allow users to win a progressive jackpot based on outcomes of multiple, different games when there have been no winners of a jackpot in those games. In one embodiment, if there has been no winner of a jackpot in multiple games that are played in a casino for a certain amount of time, a jackpot is accumulated to include all the wager money of the users who played all of those games. It should be noted that all such embodiments, or any variation thereof, are anticipated and are consistent with the spirit and scope of the present disclosure.

FIG. 6A illustrates an alternate embodiment of possible outcomes of the game that are implemented on the wager outcome indicators 116. In FIG. 6A, there are only four wager outcomes shown: two “L” wager outcomes and two “2×” wager outcomes shown in the wager outcome indicators 116. In this embodiment, each wager outcome indicator may be assigned to multiple pockets. For example, six pockets are assigned to the “L” wager outcome in the wager outcome indicator 610 and another group of six pockets are assigned to the “2X” wager outcome in the wager outcome indicator 620.

FIG. 6B illustrates an alternate embodiment of possible outcomes of the game that are implemented on the wager outcome indicators 116. In FIG. 6B, there are only three wager outcomes, all of which are shown as winning outcomes. The wager outcome “1X” in the wager outcome indicator 660 occupies a half of the wheel 111, meaning that there is a half chance that the rollable device 112 will land in the pockets 115 assigned with the “1X” wager outcome in 660. Since there is no losing outcome in FIG. 6B, this example is preferably used in instances where bonus rounds are given to the user to reward the user (e.g., a longtime customer or royal customer).

FIG. 7A illustrates an alternate embodiment of possible outcomes of the game that are implemented on the wager outcome indicators 116. FIG. 7A shows another variation of FIG. 6B. In FIG. 7A, the wager outcome “P” in 710 is replaced with the “1X” wager outcome in 660 of FIG. 6B. In the example shown in FIG. 7A, the user is given a second chance to play the game when the rollable device 112 lands in any of the pockets 115 assigned with the “P”wager outcome in 710 without losing the wager.

FIG. 7B illustrates an alternate embodiment of possible outcomes of the game that are implemented on the wager outcome indicators 116. In FIG. 7B, there is only one wager outcome in 760 with a “3X” winning outcome. In this embodiment, there is no losing outcome, and the user is guaranteed to receive the “3X” winning outcome. This example may be used in instances where bonus rounds are given to the user as a bonus reward (e.g., a long-time customer or royal customer) or as a surprising event.

FIG. 8 shows a schematic block diagram of a gaming system for playing the game according to one or more embodiments of the present disclosure. The gaming system 800 is provided for playing the game implemented on an electrical device.

In one embodiment, the gaming system 800 comprises a processor 810, a memory 820, a computer program/application 830, an interface 840, and a display 850. Interface 840 may be a manual interface, comprising mechanical components such as buttons and switches, etc. Alternatively, interface 840 may be an electronic interactive interface, such as a graphical user interface (“GUI”). In all such embodiments, however, the user may interact with, and operate, the gaming system 800 via interface 840.

In one embodiment, the GUI may be configured to interact with the user through the display 850 and/or the interface 840. In this embodiment, the GUI is provided on a display through which the user may physically interact to provide inputs concerning the play of the game. For example, the GUI may be configured to prompt the user to start the game after making a wager, by physically interacting with the GUI (e.g., touching a selectable button or option on the display). In another example, the GUI may be configured to prompt the user to launch the rollable device 112 when the game is started (e.g., touching a “Launch” or “Start” selectable option on the GUI display) and to operate the obstacles 114 (e.g., by touching a “Bumper” selectable button or option on the GUI display). In another example, the GUI may be configured to allow the user to wager (e.g., prompting the user to enter an amount or select a predetermined amount the player/user desires to wager). Any other suitable GUI may be provided for purposes of allowing the user to physically interact with the display 850 and/or the interface 840 to play the game.

In the table game embodiment, the GUI may be implemented on a display and/or an electronic device installed or placed on a game table, and the user may be allowed to interact with the GUI to play the bonus game in the same manner as described above.

In one embodiment, one or more processors 810 are capable of reading and executing logic associated with computer programs or applications 830 running on the gaming system 800. One or more processors 810 are capable of creating, manipulating, altering, and storing data and computer data structures in a non-transitory computer readable medium (e.g., the memory 820). In one embodiment, the processor 810 (and/or the application 830) may be configured to determine certain criteria or factors for playing the game. For example, the processor 810 (and/or the application 830) may be configured to (a) determine wager outcomes (or any combination thereof) for each round of the game; (b) determine the design, shape, size, layout, or structure of the wheel 111 (or any part thereof such as 112, 113, 114, 115, and 116) for each round of the game; (c) generate graphical representations of the wheel 111, the game display area 110, and/or the housing unit 105, including one or more components in the wheel 111 such as the rollable device 112, the launcher 113, the obstacles 114, the pockets 115, and the wager outcome indicators 116; (d) determine a reward/payout for each user at the end of each round of the game. In one embodiment, the above criteria or factors for the game may be implemented by a manufacturer of the gaming system 800 or the Operating Entity. In one embodiment, the processor 810 (and/or the application 830) may be configured to randomly determine the wager outcomes. In this embodiment, the processor 810 (and/or the application 830) may generate different variations of the wager outcomes for each round of the game. In another embodiment, the processor 810 (and/or the application 830) may be configured to determine the wager outcomes based on the past wager outcomes in the previous rounds of the game; the users'history of winning or losing the game in the past; or any selection made by the user or users with respect to various options of playing the game, e.g., at block 380 of FIG. 3. In another embodiment, the manufacturer (or the Operating Entity) has an option of adjusting the criteria or factors by updating the game system 800 with new software, electronic instructions, or the like. Such methods of implementing new software, electronic instructions, etc., are known in the art.

The system 800 may include persistent storage (e.g. magnetic or optical disk, PROM, flash prom or ROM, or the like) that is operable to store computer programs/applications 830, and other data that is associated with the gaming system 800. The gaming system 800 uses input and output interfaces 840 to interface with, or to communicate data with, the outside world, including users or other gaming systems or devices. Such data communication may occur directly between two systems or devices, over a local area network, over a wide area network such as the internet, wirelessly, or in any other manner known in the art for electronic data communications between two systems or devices. In some embodiments, the gaming system 800 may be configured differently without one or more of the aforementioned components.

A non-transitory computer readable medium (e.g., the memory 820) in the game system 800 is operable to store an application 830 comprising instructions that are executable by one or more processors 810 in the gaming system 800. The application 830 may be an app, a web browser, a software program, or the like, running on the gaming system 800. An app, or the like, is typically executable locally on the gaming system 800, such as a game machine, a computer, a mobile electronic device such as a smartphone or a tablet, or the like. The gaming system 800 may be in data communication with the other gaming systems or devices via any means known in the art, such as via a network like the internet, wirelessly via WiFi, via Bluetooth technology, or the like.

A user may interface with the application 830 via a user interface means associated with the gaming system 800, while corresponding computerized actions, such as methods or steps associated with practicing one or more embodiments of the present disclosure, performed either on the gaming system 800 or on another game system or device in data communication with the gaming system 800, or on a combination thereof. All such embodiments are anticipated and are deemed to be consistent with the spirit and scope of the present disclosure.

The application 830 on the gaming system 800 may be installed from a data storage medium like a CD or a USB stick, or it may be downloadable in any number of ways known in the art, such as from an application store, from a computer device or server accessible via the Internet, from a computer, from another hand-held device, or the like. The application 830 may be a software application running on a mobile electronic device such as a smartphone or a tablet, or the like.

Once the application 830 is installed, the application 830 may become a resident application on the gaming system 800. In one embodiment, the application 830 is an app and the gaming system 800 is a hand-held device such as a smartphone or a tablet. In such embodiment, the gaming system 800 is mobile, and the user is able to play the game through his or her mobile device. In another embodiment, the application 830 is a software program running on a desktop or a laptop computer. In this embodiment, the gaming system 800 is installed in physical locations such as a casino, a restaurant, etc., where the user is able to play the game. In some embodiments, the user may be able to play the game with other users. In an alternate embodiment, the application 830 is a browser running on the computer device.

In one embodiment, the application 830 comprises instructions executable by the processor 810. The application 830 and processor 810 interface with a non-transitory computer readable medium, such as the memory 820. The term application is used in some instances to refer to an installed mobile app on a hand-held device, such as on a mobile communications device, smartphone, or the like. However, as a practical matter, the terms application and app may be used interchangeably. Accordingly, the functions described herein may be performed by software running on a personal computer or on a hand-held device, and therefore various terms may be used interchangeably while the methods described herein will apply to most such embodiments.

Referring to FIG. 8, a GUI of the display 850 may be configured to display the game, the progression of the game, or both. In one embodiment, the display 850 may be configured to display the game displaying area 110 and/or the housing unit 105. In another embodiment, the display 850 may comprise one or more separate screens or monitors such that one screen or monitor is configured to display the game while a different screen or monitor is configured to display the other information that is described to be shown through the display 130, as shown in FIG. 1. Alternatively, the display 850 may be configured to display the game displaying area 110 on a first screen/monitor, the display 130 on a second screen/monitor, and the progressive jackpot on a third screen/monitor. In another embodiment, the display 850 may be configured to display the game and the progressive jackpot) in a single screen or monitor. In this embodiment, the display 850 may be configured to provide multiple sub-sections on its screen, thereby displaying different information in each of those sub-sections.

The interface 840 may be configured to provide control functionalities for the user to play the game. For example, the interface 840 may serve as the input device 120 and/or the tray 140 of FIG. 1. In one embodiment, the interface 840 may be configured to provide an interface for the user to pay money or purchase credits for playing the game and/or making a wager. In another embodiment, the interface 840 may be configured to provide an interface for the user to receive a reward, credits, a payout, or the like, such as when the user is finished playing the game.

In one embodiment, the interface 840 and/or the GUI may be configured to provide physical interaction with the user for playing the game, as described above with respect to FIGS. 1, 2, and 3.

The methods and algorithms illustrated and discussed herein may have various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules, units, or other components, can be combined or segregated as hardware and/or software stored on a non-transitory computer-readable medium as modules in any manner, and can be used separately or in combination.

Although the devices, systems, apparatus and methods have been described and illustrated in connection with certain embodiments, variations and modifications will be evident to those skilled in the art. Such variations and modifications may be made without departing from the spirit and scope of the present disclosure, and are therefore anticipated. The description and teachings herein are thus not to be limited to the precise details of methodology or construction set forth herein because variations and modifications are intended to fall within the spirit and scope of the present disclosure.

1. A method of providing a game, comprising:
providing a game display area, the game display area comprising:
a rollable device configured to move in the game display area;
a launcher configured to launch the rollable device in the game display area;
a wheel having a plurality of pockets, each configured to receive the rollable device and assigned a wager outcome indicator configured to indicate a wager outcome;
at least one obstacle configured (a) to impact a path or direction of a movement of the rollable device when the rollable device encounters said at least one obstacle and (b) to be activated when said rollable device encounters said at least one obstacle;
providing a user interface to a user; and
allowing the user to determine a wager amount by selectively operating said user interface.

2. The method of claim 1, wherein the wager outcome is not displayed to the user until after the user determines the wager amount.

3. The method of claim 1, further comprising:
providing a plurality of rollable devices, wherein each of said plurality of rollable device is configured to land in one of said plurality of pockets.

4. The method of claim 1, further comprising:
determining a payout based on a wager outcome indicator assigned to one of said plurality of pockets in which the rollable device is received.

5. The method of claim 4, wherein the wager outcome is one of a winning outcome or a losing outcome.

6. The method of claim 5, wherein if the wager outcome is the winning outcome, then the payout is increased by an amount calculated based on the winning outcome.

7. The method of claim 5, wherein if the wager outcome is the losing outcome, then the payout is decreased by an amount calculated based on the losing outcome.

8. The method of claim 1, further comprising displaying the game display area on an electronic device.

9. The method of claim 1, further comprising displaying a movement of the wheel, the movement of the wheel comprises spinning of the wheel, wherein said spinning is triggered by launching the rollable device.

10. The method of claim 1, wherein the rollable device is a ball or a die.

11. The method of claim 1, further comprising allowing the user to selectively activate said at least one obstacle by selectively operating said user interface.

12. The method of claim 11, further comprising determining a payout when said at least one obstacle is activated, wherein the payout is determined based on a special value assigned to said at least one obstacle.

13. The method of claim 12, wherein the special value is one of a winning value or a losing value.

14. The method of claim 1, further comprising allowing the user to operate said at least one obstacle by selectively operating said user interface, said operation comprises a movement of said at least one obstacle in different angles.

15. The method of claim 1, wherein said at least one obstacle is one of a bumper, a flap, a kicker, a paddle, or a deflector.

16. The method of claim 1, further comprising:
providing a plurality of obstacles in the game display area; and
allowing the user to operate said plurality of obstacles by selectively operating said user interface, wherein said operation comprises a movement of at least one of said plurality of obstacles in different angles.

17. The method of claim 1, wherein two or more of said plurality of pockets are assigned to the wager outcome indicator.

18. A method for playing a game, the method performed by a gaming system comprising at least one processor and at least one memory, the at least one memory comprising instructions executed by the at least one processor to perform the method, the method comprising:
receiving a wager amount from a user, wherein the user determines the wager amount via a user interface on an electronic device;
generating a first set of wager outcomes;
displaying a game display area on a graphical user interface (GUI) of the electronic device, the game display area comprising:
a rollable device configured to move in the game display area;
a launcher for launching the rollable device;
a wheel comprising a plurality of pockets, each of said plurality of pockets configured to receive the rollable device and assigned one of said first set of wager outcomes; and
at least one obstacle configured to impact a path or direction of a movement of the rollable device when the rollable device encounters said at least one obstacle; and
displaying at least one of said first set of wager outcomes to the user on the GUI of the electronic device;
launching the rollable device; and
determining a payout based on one of said first set of wager outcomes that is assigned to one of said plurality of pockets in which the rollable device is received.

19. The method of claim 18, wherein the one of said first set of wager outcomes is one of a winning outcome or a losing outcome.

20. The method of claim 19, wherein if said one of said first set of wager outcomes is a winning outcome, then the payout is increased by an amount calculated based on the winning outcome.

21. The method of claim 19, wherein if said one of said first set of wager outcomes is a losing outcome, then the payout is decreased by an amount calculated based on the losing outcome.

22. The method of claim 18, wherein the game display area further comprises a plurality of wager outcome indicators, each configured to display one of said first set of wager outcomes.

23. The method of claim 18, further comprising allowing the user to operate said launcher, said operation comprises launching of said launcher.

24. The method of claim 18, further comprising:
displaying a movement of the wheel on the GUI, said movement comprises spinning of the wheel wherein said spinning is triggered by launching the rollable device.

25. The method of claim 18, further comprising:
displaying the movement of the rollable device, said movement comprises traveling within the game display area, wherein said movement of the rollable device is triggered by launching the rollable device.

26. The method of claim 18, further comprising:
allowing, by said user interface, the user to operate said at least one obstacle, said operation comprises moving of said at least one obstacle in various directions.

27. The method of claim 18, further comprising presenting the user an option on the GUI to select a design of the wheel via said user interface.

28. The method of claim 27, wherein said option comprises presenting a plurality of designs of the wheel to the user on the GUI.

29. The method of claim 28, wherein said plurality of designs of the wheel comprises a plurality of designs of said launcher and a plurality of designs of said at least one obstacle.

30. The method of claim 18, further comprising generating a second set of wager outcomes, wherein at least one of said second set of wager outcomes is different from said first set of wager outcomes.

31. The method of claim 18, further comprising activating said at least one obstacle, said activation is triggered when said at least one obstacle is hit by the rollable device.

32. The method of claim 31, further comprising:
assigning a special value to said at least one obstacle; and
adjusting the payout when said at least one obstacle is activated, wherein the payout is adjusted based on the special value.

33. The method of claim 32, wherein the special value is one of a winning value or a losing value.

34. The method of claim 18, wherein said at least one obstacle is one of a bumper, a flap, a kicker, a paddle, or a deflector.
